(19) United States
(12) Patent Application Publication
(10) Pub. No.: US 2005/0015479 A1
(43) Pub. Date: Jan. 20, 2005

(54) Software support guide system and method

(76) Inventors: Charles E. Reddick, Palatka, FL (US); Roy Edward Glascoe JR., Alpharetta, GA (US)

Correspondence Address: CANTOR COLBURN LLP, 55 GRIFFIN ROAD SOUTH, BLOOMFIELD, CT, 06002, US

(21) Appl. No.: 10/916,689

(22) Filed: Aug. 11, 2004

Related U.S. Application Data
(63) Continuation of application No. 09/898,573, filed on Jul. 3, 2001.

(51) Int. Cl. G06F 15/173

(52) U.S. Cl. 709/223

(57) ABSTRACT

A computerized guide system and method include instructions for transferring software from a server in a network to telecommunications equipment in a remote location using a mobile computer. Instructions for accessing, downloading, and transferring updated software programs that are self-guided are advantageous for independent use by technicians. Instructions of such a guide and method are accessible at a plurality of locations at the same time to a plurality of technicians servicing telecommunications equipment, such as multiplexers of different vendors.

### CROSS-REFERENCE TO RELATED APPLICATIONS

This application is a continuation of U.S. patent application Ser. No. 09/898,573 filed Jul. 3, 2001, the contents of which are incorporated by reference herein in their entirety.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to a computerized guide system and method, and a system and method for transferring software from a server in a network to telecommunications equipment in a remote location using a mobile computer. Embodiments of the present invention provide a guide having self-guided instructions advantageous for independent use by technicians to transfer updated software to hardware, such as multiplexers of different vendors.

### BACKGROUND OF THE INVENTION

Historically, maintenance of telecommunications equipment at many remote locations throughout a telecommunications system has been one of the most significant aspects of providing reliable service to customers. Maintaining telecommunications equipment, such as multiplexers, in remote locations is a key component of such reliability.

A conventional approach to servicing telecommunications equipment with software at remote sites involves providing software-containing disks to the remote sites and a person specially trained in software installation loading the software on a local computer, among other things. This approach is disadvantageous in that it creates variations in service among locations and among technicians. For example, technicians in one location may have the newest applications and the newest versions of software, while technicians in other locations may not have the latest version or even the same application. In some instances, software available to technicians in remote locations may be several years old or otherwise outdated.

Conventional approaches to maintenance of digital loop electronics have not previously used effective, quick, and comprehensive support means in a network environment. In a telecommunications system, a conventional way for an end-user of software to learn about and access a newer version of the software involved the company purchasing a multiplexer, for example, accompanied by new software. When the multiplexer is installed, disks for the new software would be delivered to a technician. The technician would then realize that new software, or a newer version of software, was available and either load the software onto a local computer or have a computer technician load the software onto a computer. Additionally, after loading a newer version of software, a technician would often shelve the copy of the new software, making it inaccessible, or not easily accessible, to other technicians. Such aspects of conventional systems are disadvantageous in that technicians at sites where new equipment has not been recently installed may not be aware of the availability of updated software and/or be able to quickly and easily access such software.

Another disadvantage with such an approach to remote equipment maintenance is that a technician would have available at a remote multiplexer site only the software related to that particular manufacturer's multiplexer. To partially address these issues, mobile computers have been provided to technicians in the field. Providing mobile computers in the field that are able to use software from a central server for servicing telecommunications equipment allows an increased capability for testing and servicing such equipment.

Conventionally, to provide maintenance for telecommunications equipment in the field, technicians using a portable computer having software loaded onto the computer transport the computer to a remote site where the computer is connected to the equipment. However, maintenance and repair of telecommunications equipment in the field has in the past been inefficient and inconsistent among the large number of technicians attempting such work. Service outcomes are particularly variable when a job involves equipment, such as multiplexers, that uses software. A multiplexer comprises, for example, a telecommunications device that combines a number of individual communications channels into a common frequency band or a common bit stream for transmission, usually over a single circuit. Multiplexing methods, such as frequency division, time division, code division, and wavelength division, make more efficient use of transmission capacity to achieve a lower per-channel cost.

Multiplexer problems can subject a large number of customers to outages of service. When technicians use different versions of installation, maintenance, and repair software in relation to the same type of multiplexer, service of multiplexers varies between technicians. Thus, there is a need to provide a means for improving consistency of software use and thus quality and reliability of service performance among technicians.

Variability of service involving software for equipment, such as multiplexers, is related to individual technicians having different versions of software programs at various multiplexer sites and/or not having the newest version of a program. To improve consistency and reliability of service among technicians, there is a need to provide the same version of all software programs at all multiplexer sites. Another reason for inefficient use of software, even if the newest version is available to a technician, is the technician's unfamiliarity with the software, particularly a newer version than used previously. Moreover, technicians unfamiliar with new software are less likely to use the new software, leading to less-than- optimal service of equipment and inefficiencies in telecommunications service for customers. As such, there is a need to provide timely training on new software for technicians at multiple locations in the field.

Technicians that use software for routine maintenance in multiple locations often vary in levels of training and experience. For example, some technicians may be trained only in “plain old telephone” repair, while others are capable of providing special services, and still others are competent using sophisticated software, such as that utilized with digital loop electronics. To address software education needs in the field for technicians having disparate levels of training and experience, companies often send a trainer to sites where technicians are located. This approach to on-site education is disadvantageous in that it requires a trainer to travel to numerous locations around a telecommunications network, an approach which is slow and requires a large amount of human resources, including down time for technicians to travel to educational settings away from work sites. Another disadvantage of providing on-site training with a live trainer at multiple locations is that by the time training has occurred for all technicians at all sites, newer software may be available, requiring the education process to start over. In such an approach, technicians would still not have training on the newest version of software at the same time. Additionally, education provided by different trainers can vary. Consequently, on-site software education with a live trainer for large numbers of telecommunications service technicians is time-consuming, labor-intensive, expensive, and subject to undesirable variables in the education.

Another approach to software training for technicians in the field involves use of videotaped education. Videotaped software education at multiple locations has several disadvantages, including being a more passive and less effective form of education and requiring initiation of the educational session by individuals, or small groups of technicians. In addition, production of videotape education is often expensive, requires updates for each new software program, and involves distribution of videotapes, possibly along with copies of the subject software, to numerous locations each time a new version of software is available.

Thus, there is a need for on-site software education for telecommunications technicians at multiple locations at the same time for the newest version of software that is effective, efficient, and cost-effective. There is also a need for an instructional guide for updating computers with needed software without the assistance of other persons or devices, such as disks containing software programs. Further, there is a need for processes and systems that do not have, or that reduce, the disadvantages of the conventional systems discussed above, and that provide other advantages.

It is to these perceived needs, and other objects, that the present invention is directed.

### SUMMARY

Embodiments of the present invention provide a computerized guide for transferring software from a server in a network to telecommunications equipment in a remote location using a mobile computer comprising instructions for technicians performing such operations in the field. Such instructions include instructions for accessing a software program on a server; downloading a software program from the server to a mobile computer; connecting the mobile computer to the equipment; accessing the software program downloaded onto the mobile computer; and transferring the software program from the mobile computer to the equipment. Instructions for accessing, downloading, and transferring the software program in a guide in embodiments of the present invention are accessible at a plurality of locations at the same time to a plurality of technicians servicing telecommunications equipment. Preferably, a software program loaded on a server to be transferred is an updated version of the software program. Instructions in a computerized guide in embodiments of the present invention comprise self-guided instructions adapted for independent use by a technician.

These systems have particular use with multiplexers, but may be used in a variety of situations. Embodiments of the present invention provide a guide for transferring software from a server to telecommunications equipment, wherein the telecommunications equipment is a multiplexer. An embodiment of such a guide for transferring software from a server to a multiplexer includes instructions for accessing, downloading, and transferring digital loop electronics software. Embodiments of a guide of the present invention comprise instructions related to software programs for telecommunications equipment of a plurality of vendors.

Embodiments of the present invention also include a method of using a computerized guide for transferring software from a server in a network to telecommunications equipment in a remote location using a mobile computer. In one embodiment, a method of using a computerized guide of the present invention comprises loading updated versions of software programs on a network server; providing a guide adapted for independent use by a technician having self-guided instructions for accessing, downloading, and transferring a software program from the server to the equipment; and following the instructions in the guide to access, download, transfer the software program from the server to the equipment. Instructions in a guide in such a method in embodiments of the present invention are accessible at a plurality of locations at the same time to a plurality of technicians servicing the telecommunications equipment.

Embodiments of a method of the present invention also include loading updated versions of software programs on a network server for a plurality of equipment in use in a telecommunications system. Other embodiments of a method include providing a guide having instructions for accessing software programs for the telecommunications equipment of a plurality of vendors.

A method in embodiments of the present invention comprises following instructions in a guide for transferring software from a server in a network to remote telecommunications equipment, wherein the telecommunications equipment is a multiplexer. In such a method, following instructions in a guide for transferring software from a server to a multiplexer includes instructions for accessing, downloading, and transferring digital loop electronics software.

Features of a computerized guide for transferring software of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

A computerized guide according to embodiments of the present invention for transferring software from a server in a network to remote telecommunications equipment using a mobile computer provides numerous advantages over prior approaches to servicing such equipment in the field. For example, embodiments of the present invention advantageously provides a computerized support guide that improves efficiency, consistency, and reliability of technical support for telecommunications equipment among a number of technicians at remote sites.

Embodiments of the present invention provide the advantage of allowing technicians with varying levels of experience and competency at remote locations in a telecommunications system the ability to transfer updated software to a remote computer for servicing equipment in a self-guided manner, optimally without other assistance. Providing a computerized guide, as in embodiments of the present invention, that includes instructions in a step-by-step process for how to use a computer and for accessing and using a dial-up connection to a network, for accessing and using a server in the network, and for accessing and using file transfer protocol software for transferring software programs allows technicians to work much more independently and efficiently. As a result, technicians not highly trained in use of computers or in use of software programs for particular equipment can work through steps without other assistance to service remotely located equipment. Another advantage of such a guide is that technicians place fewer calls to a system help desk.

Another advantage is that embodiments of the present invention provides a guide for transferring updated versions of software from a server in a network to multiplexers of different vendors at remote locations using a mobile computer. Such a guide provides a means for improving consistency of software use and decreasing service variability among technicians servicing a variety of multiplexers. As a result, enhanced quality and reliability of service performance among technicians leads to decreased outages and improved customer service.

Another advantage is that embodiments of the present invention provides a guide that utilizes an icon associated with a particular software program and a description of the program, its functionality, and how to access that program. Thus, such a guide beneficially provides instructions that include cues for using a mobile computer to access, download, and transfer software programs.

Another advantage is that embodiments of the present invention provides a printed guide and/or an on-line guide. Still another advantage is that technicians using the guide and method of embodiments of the present invention are able to remotely access all systems in a network. In addition, such a guide and method allows technicians at each remote site in a connected computer network to have the latest version of all software programs available on the network server.

A guide and method of embodiments of the present invention also advantageously increase efficiency in servicing complex equipment at remote sites by making updated software and instructions for use of such software accessible at a plurality of remote locations at the same time. In particular, a guide and method of embodiments of the present invention allow for efficiencies in servicing telecommunications multiplexers with the latest versions of centrally accessible software in multiple remote locations at the same time.

Embodiments of the present invention also provides the advantage of supporting remote telecommunications equipment service with centrally accessible, updated software programs for a plurality of vendor-specific equipment, such as multiplexers. As such, embodiments of the present invention provide for the same level and quality of maintenance on different equipment throughout a telecommunications system. Another advantage is that when a multiplexer at a remote site is changed from that of one manufacturer to that of another, embodiments of the present invention allows technicians a readily available and self-guided access to the latest versions of software for the new multiplexer, regardless of the manufacturer. Accordingly, embodiments of the present invention provide a means for improving consistency of software use and thus quality and reliability of service performance among a plurality of technicians servicing equipment of different vendors in remote locations of a telecommunications system.

As will be realized by those of skill in the art, many different embodiments of a computerized guide for transferring software from a server in a network to remote telecommunications equipment using a mobile computer according to embodiments of the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is an illustration of a computer network having a computerized guide for transferring software programs from a server to telecommunications equipment at remote locations in an embodiment of the present invention.

FIGS. 2A and 2B comprise an illustration of instructions in a computerized guide related to accessing and using software for multiplexers of different vendors in an embodiment of the present invention.

FIG. 3 is an illustration of instructions in a computerized guide related to using a computer in an embodiment of the present invention.

FIG. 4 is an illustration of instructions in a computerized guide related to accessing and using a dial-up connection in an embodiment of the present invention.

FIG. 5 is an illustration of instructions in a computerized guide related to accessing and using a database on a server in an embodiment of the present invention.

FIG. 6 is an illustration of instructions in a computerized guide related to another database on a server in an embodiment of the present invention.

FIG. 7 is an illustration of instructions in a computerized guide related to accessing and using testing software in an embodiment of the present invention.

FIG. 8 is an illustration of instructions in a computerized guide related to accessing and using file transfer protocol software in an embodiment of the present invention.

FIG. 9 an illustration of instructions in a computerized guide related to accessing and using software for multiplexers of different vendors in an embodiment of the present invention.

FIG. 10 is a schematic flow chart representing steps in an embodiment of a method of the present invention.

FIG. 11 is a schematic flow chart representing steps in an embodiment of a method of the present invention.

### DETAILED DESCRIPTION

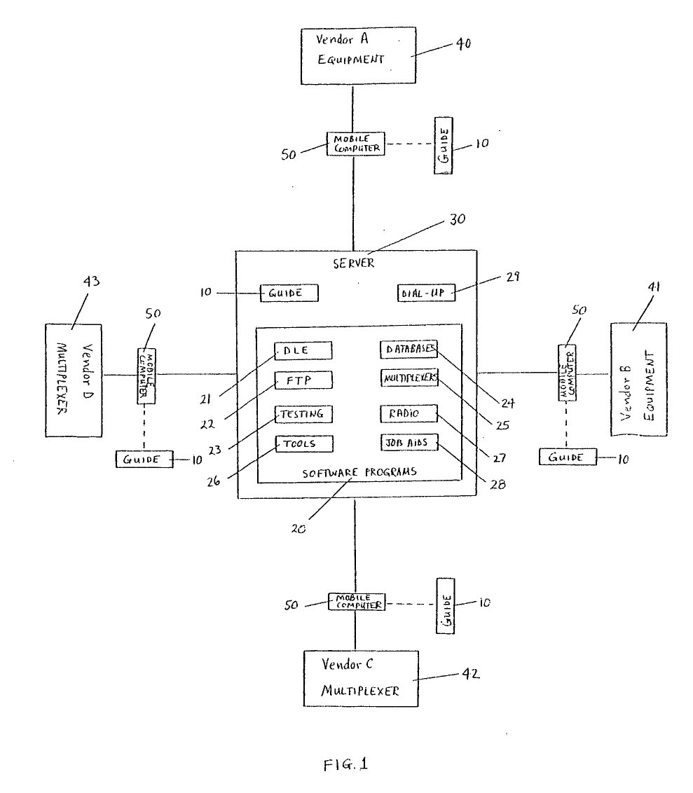

FIGS. 1-10 show various aspects of embodiments of the present invention. One embodiment comprises a computerized guide for transferring software programs from a server in a computer network to telecommunications equipment at remote locations using a mobile computer. FIG. 1 shows one such embodiment.

Referring to FIG. 1, a central server 30 is connected in a computer network to mobile computers 50 at different locations. Mobile computers 50 are located at sites in a telecommunications system remote from central server 30 where telecommunications equipment 40, 41, 42, 43 are located. A computerized guide 10 resides on server 30 and/or is located at remote equipment sites, for use with mobile computers 50. In addition, the guide 10 can be an on-line guide and/or a printed guide. Examples of mobile computers include personal computers, including laptop computers, hand-held computers, personal digital assistants, processors, and radio frequency devices, among others. Examples of telecommunications equipment include multiplexers, switches, routers, modems, digital subscriber equipment, and the like.

Software programs 20 useful in servicing telecommunications equipment are loaded onto server 30. Such software programs include programs relating to digital loop electronics (DLE) 21, a file transfer protocol (FTP) 22, computer testing functions 23, databases 24, multiplexers 25, computer tools 26, computer radio functions 27, and computerized job aids 28. A dial-up connection software program 29 is also loaded on server 30. Preferably, software programs 20 loaded on server 30 are updated versions of the software.

In such a system, a technician accesses and downloads software programs 20 from server 30 to a mobile computer 50 at a remote equipment site. The technician then connects the mobile computer 50 to a piece of equipment to be serviced. Once such a connection is made, software programs 20 downloaded to the mobile computer 50 are accessed and transferred to equipment 40, 41, 42, 43.

Equipment used at remote locations in a telecommunications system can be provided by different manufacturers, or vendors. As shown in FIG. 1, for example, equipment 40 is provided by Vendor A, and equipment 41 is provided by Vendor B. Equipment 42, which is a multiplexer, is provided by Vendor C, and equipment 43, also a multiplexer, is provided by Vendor D. Thus, embodiments of the present invention provide a guide 10 for transferring software programs 20 from a central server 30 to remote telecommunications equipment 40, 41, 42, 43 of a plurality of vendors. In preferred embodiments, such a guide includes, and provides instructions for transferring specific software programs for use with multiplexer equipment 42, 43 of a plurality of vendors. For example, digital loop electronics software 21 on server 30 is software for use with particular multiplexer equipment. Accordingly, a guide for transferring updated software programs from a central server to remote telecommunications equipment, including multiplexers, of different vendors is accessible at a plurality of locations at the same time. As a result, servicing telecommunications equipment at remote locations is more consistent, efficient, and effective.

Instructions, in the embodiments shown, comprise data represented by written text and visual images. Such data representations include printed materials, displays on a computer screen, and other audio and visual information. Instructions include and provide details and directions for performing procedures and operations to accomplish a task. Data- based instructions are adapted for storing in various media, such as information bytes on a computer server or hard drive and on a portable diskette, and as words and graphic illustrations in a book or manual. Such instructions are retrievable for imparting education, training, tutoring, and other coaching and prompting to aid in successful task completion.

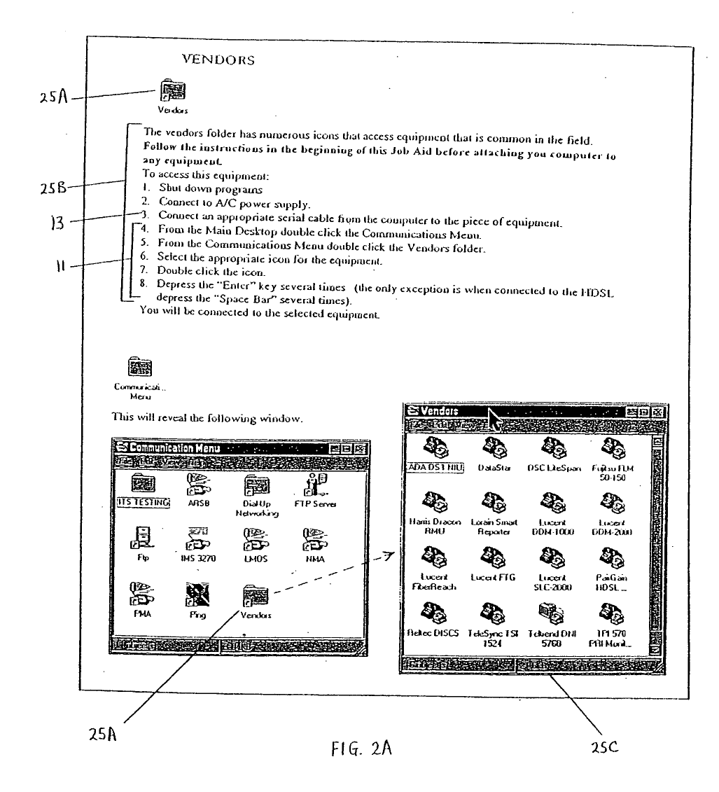

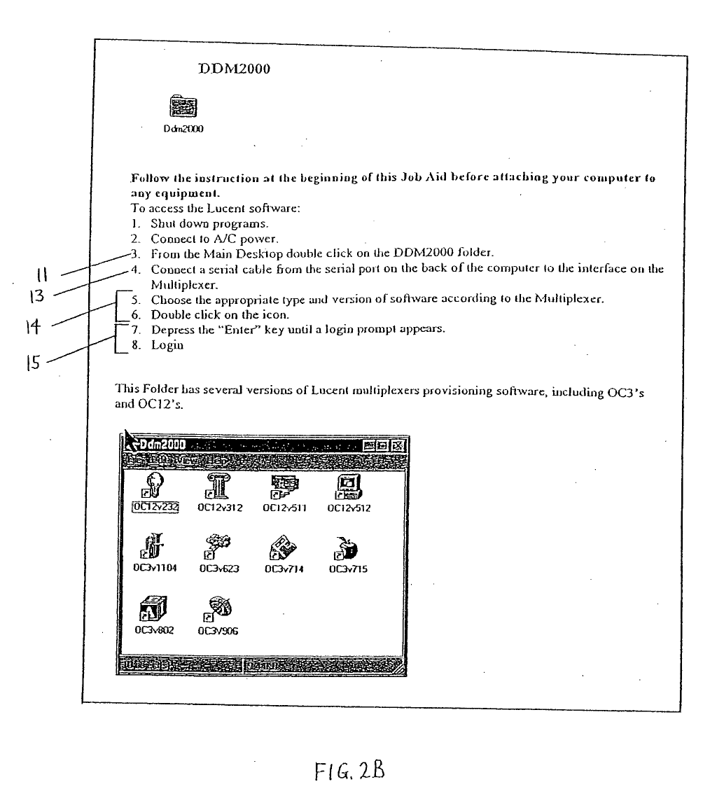

FIGS. 2A and 2B show an embodiment of a guide comprising instructions 25B include software program accessing instructions 11. The software program accessing instructions 11 comprise written instructions to a technician in the printed guide for accessing, for example, running, a software program on a server. The instructions 11 illustrate that double clicking Communications Menu 19 reveals a window displaying an icon for vendors 25A. Instructions 11 further illustrate that double clicking the vendors folder reveals a window of icons for software for various equipment, including multiplexers, of different vendors. Double clicking on the icon for a particular multiplexer, for example the “Lucent DDM-2000” multiplexer 25D, reveals a window displaying icons of software programs for that multiplexer, as shown in FIG. 2B. Referring to FIG. 2B, the guide includes mobile computer and multiplexer connection instructions 13 for connecting a mobile computer to the multiplexer; software program downloading instructions 14 for accessing the software program downloaded onto the mobile computer; and software program transferring instructions 15 for logging in and transferring the software program from the mobile computer to the multiplexer.

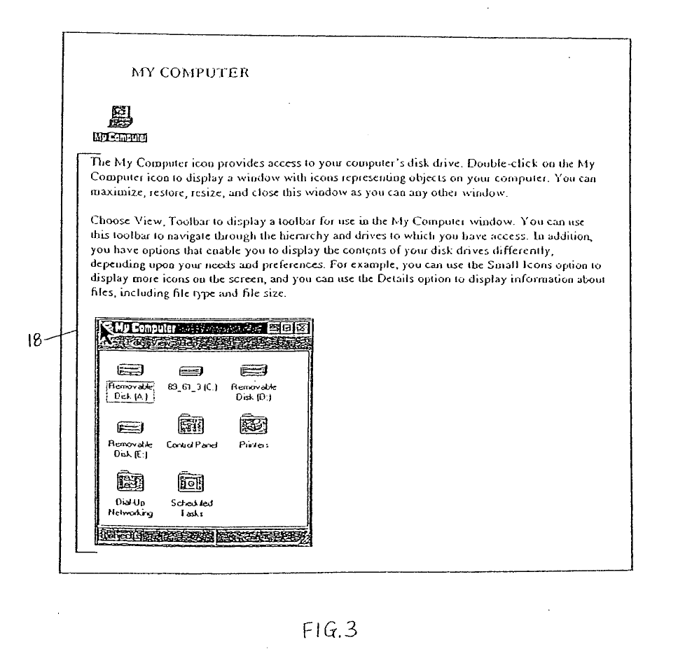

Transferring software from a central server to remote telecommunications equipment using a mobile computer involves a number of steps. Embodiments of a computerized guide comprise self-guided instructions for the plurality of steps involved, adapted for independent use by a technician. As an example, FIG. 3 shows an embodiment of a guide having instructions 18 for accessing and using various features of and attachments to a personal computer, such as disk drives and printers. A guide having instructions for how to use a computer allows technicians not trained or experienced in computer use to access and use software from a server for servicing equipment without assistance, or with minimal assistance, of others.

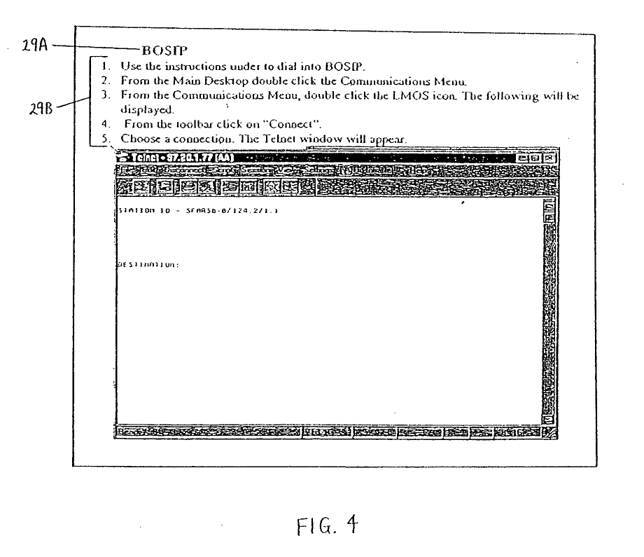

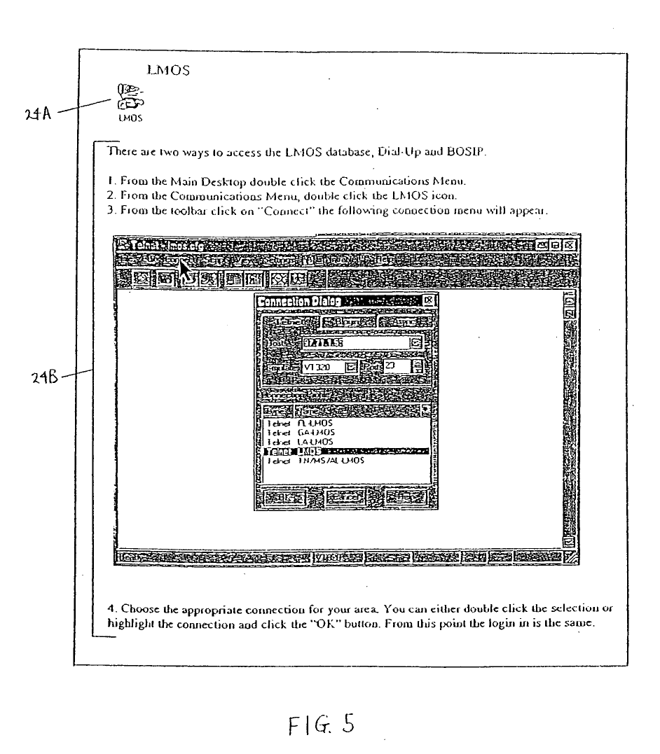

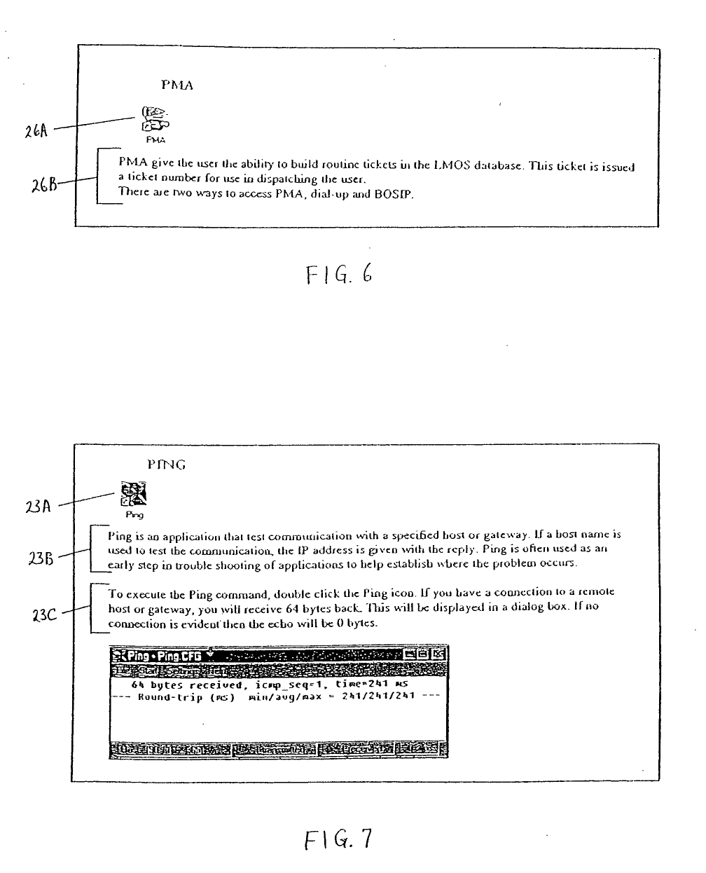

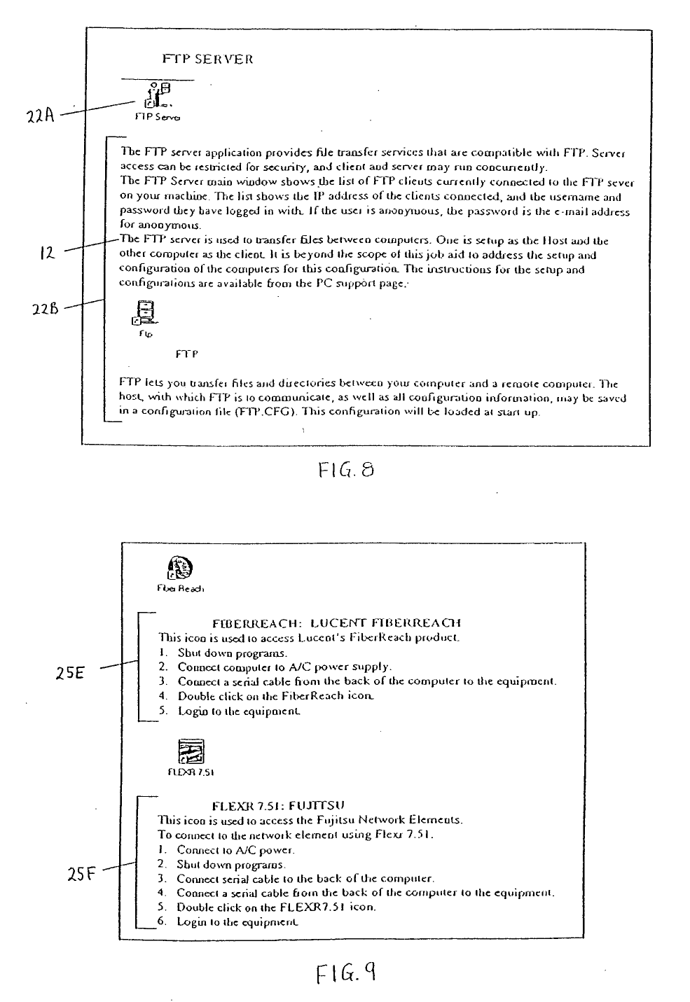

As shown in FIG. 4, another embodiment of a guide comprises instructions 29B using the communications program “BOSIP” 29A for making a dial-up connection to an internal network from a mobile computer. “BOSIP” 29A is a communications software program that includes a gateway to a network. Other embodiments include instructions for accessing and using software on a network server. For example, as shown in FIG. 5, one embodiment of a guide includes instructions 24B for accessing the “LMOS”, or Loop Maintenance Operation System, database 24A on a server. In another embodiment, as shown in FIG. 6, a guide includes instructions 26B for accessing the “PMA” database management tool 26A. “PMA” 26A is a database management tool that provides the ability to build routine tickets in other databases for use in dispatching a user. In yet another embodiment, as shown in FIG. 7, a guide includes instructions 23B, 23C for using the “PING” communications test program 23A. “PING” 23A is an application that tests communications with a specified host or gateway. “PING” involves sending out a signal to determine connection with a particular transmission control protocol/internet protocol (TCP/IP) address and is used in trouble-shooting software applications to identify where a problem occurs. In still another embodiment, as shown in FIG. 8, the guide includes instructions 22B for accessing a file transfer protocol (FTP) software program 22A for transferring software files to remote telecommunications equipment. Instructions 22B further include software program downloading instructions 12 for downloading a software program from a server to using FTP software.

The computerized guide in FIG. 7 shows self-guided instructions displaying a computer icon. Computer icons displayed in a guide represent similar icons as would be seen by a technician on a mobile computer screen. The guide also includes a description of the software program associated with the icon. Referring to FIG. 7, the icon labeled “Ping” is displayed to represent the software program “PING” 23A. Under the display of the “PING” 23A icon is a description 23B of the “PING” program as a software application that tests communication with a specified host or gateway. The guide then provides specific instructions 23C as to how to access the “PING” software program 23A using the “PING” icon and how to use program 23A to determine if a proper connection to a remote host or gateway is made. Use of such displays of computer icons and associated descriptions enhances the degree to which a technician can use a guide in an efficient, self-guided manner.

Referring to FIG. 1, embodiments of guide 10 provide instructions for transferring different types of software programs 20 useful in servicing telecommunications equipment. In one embodiment, for example, the guide 10 comprises instructions for transferring testing software 23. In another embodiment, the guide 10 includes instructions for accessing and using software programs for mobile computer tools 26. Such mobile computer tools 26 include, for example, software programs for battery status checks, battery maintenance, tips on maintaining a battery at optimum levels, computer display, and use of a modem terminal. Other embodiments of guide 10 include instructions for accessing and using software programs for servicing radio functions 25 on mobile computers 50. Software programs for servicing mobile computer radio functions 25 include, for example, programs for checking radio status, radio debugging, and radio terminal servicing.

In still other embodiments, guide 10 includes instructions for accessing and using software programs adapted as job aids 28 for servicing telecommunications equipment at remote sites. Such computerized job aids 28 include updated versions of software programs relating to changes, for example, in engineering, card compatibility, technical documentation, and other equipment specifications. As an example, FIG. 9 shows an embodiment of a guide having instructions 25E and 25F using software programs related to servicing multiplexers of two different vendors. Other examples of job aids 28 (not shown) for which instructions are provided in embodiments of a computerized guide include: functions and configurations of different cards associated with a variety of channel banks; digital data service (DDS) functions; an integrated test system (ITS); and document access and viewing, among others.

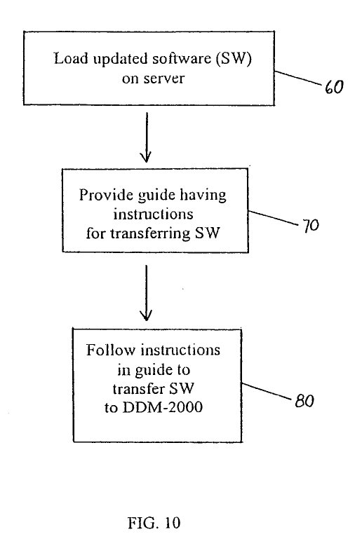

Embodiments of the present invention include a method of using a computerized guide for transferring software from a server in a network to telecommunications equipment in a remote location using a mobile computer. One embodiment of such a method is shown in FIG. 10. Referring to FIG. 10, the method comprises first loading updated versions of software programs on a network server (60). The method includes providing a guide with step-by-step instructions (70) for accessing, downloading, and transferring the software. The method further includes following the instructions (80) in the guide to access, download, and transfer updated software programs from the server to telecommunications equipment. Preferably, the guide has self-guided instructions adapted for independent use by a technician.

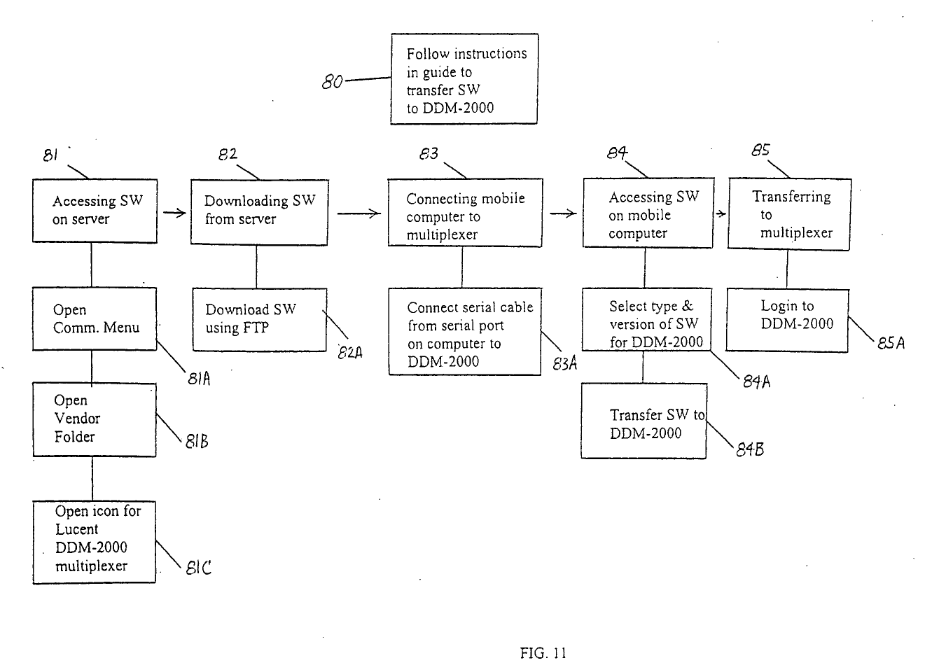

FIG. 11 shows another embodiment of a such method comprising following instructions (80) in a guide to access, download, and transfer updated software programs from a server to telecommunications equipment. Following the instructions in the guide includes following written instructions 81 for accessing a software program on a server. Such instructions 81 include, for example, opening a communications menu (81A) on a computer screen to reveal a window displaying an icon for vendors. Following instructions to open the vendor folder (81B) reveal a window of icons for software for various equipment, including multiplexers, of different vendors. Following instructions for opening the icon for a particular multiplexer (81C), for example the “Lucent DDM-2000” multiplexer, reveals a window displaying icons of software programs for that multiplexer.

The method shown in FIG. 11 also includes following instructions 82 for downloading a software program, such as the “Lucent DDM-2000” multiplexer software, from the server to the mobile computer. In particular, following instructions 82 comprise downloading the software using a FTP program (82A). The method further includes following instructions 83 for connecting the mobile computer to the multiplexer. Such instructions 83 comprise connecting a serial cable from a serial port on the mobile computer to the interface on the “Lucent DDM-2000” multiplexer (83A). The method further includes following instructions 84 for accessing the software program downloaded onto the mobile computer, for example, selecting the type and version of software on the mobile computer desired for the “Lucent DDM-2000” multiplexer (84A). The method further includes following instructions 85 for transferring the software program from the mobile computer to the multiplexer. Such instructions 85 comprise logging in to the “Lucent DDM-2000” multiplexer (85A) and transferring the selected software to the multiplexer (85B).

Providing such a computerized guide allows instructions for transferring software to be accessible at a plurality of locations at the same time to a plurality of technicians servicing telecommunications equipment. In another embodiment, such a method includes sending an electronic mail message to each mobile computer in a network when the updated versions of software programs are available on the network server, further enhancing the timeliness and efficiency of servicing remote equipment.

The computerized guide can be provided in various formats. For example, in embodiments, the guide comprises a printed guide and/or an on-line guide, accessible over the network. In other embodiments, wherein both a printed guide and an on-line guide are provided, after following the instructions in the printed guide, a technician thereafter follows the instructions only in the on-line guide as needed.

The guide provided in embodiments of a method includes instructions displaying computer icons. Each icon is associated with a software program. The instructions further comprise a description of the software program associated with each icon. For example, FIG. 7 shows an icon displayed for the software program “PING” 23A, and a description 23B of the program as a communications test program that tests. FIG. 8 shows a different icon displayed for the software program “FTP” 22A, and a description 22B of “FTP” as an application that provides file transfer services.

Referring to FIG. 1, embodiments of a method as described above include providing a guide having instructions for transferring testing software 23. In other embodiments, the guide includes instructions for accessing and using software programs for mobile computer tools 26. In yet other embodiments, the guide includes instructions for accessing and using software programs for servicing radio functions 27 on mobile computers. In still other embodiments, the guide includes instructions for accessing and using software programs adapted as job aids 28 for servicing telecommunications equipment.

Although the present invention has been described with reference to particular embodiments, it should be recognized that these embodiments are merely illustrative of the principles of the present invention. Those of ordinary skill in the art will appreciate that a computerized guide for transferring software from a server in a network to telecommunications equipment in a remote location using a mobile computer of the present invention may be constructed and implemented in other ways and embodiments. Accordingly, the description herein should not be read as limiting the present invention, as other embodiments also fall within the scope of the present invention.

1. A system for transferring a software program comprising:
a server having access to the software program;
a mobile computer in communication with the server over a network for receiving the software program from the server;
a computerized guide system including:
software program accessing instructions;
software program downloading instructions;
software program transferring instructions; and
mobile computer and telecommunications equipment connection instructions,
wherein the software program accessing instructions, the software program downloading instructions, the software program transferring instructions, and the mobile computer and telecommunications equipment connection instructions are accessible at a plurality of locations at the same time to a plurality of technicians servicing the telecommunications equipment.

2. The system of claim 1, wherein each set of instructions further comprises self-guided instructions adapted for independent use by a technician.

3. The system of claim 1, wherein at least one set of instructions further comprises a display of an icon.

4. The system of claim 3, wherein the icon is associated with the software program and the at least one set of instructions further comprises a description of the software program associated with the icon.

5. The system of claim 1, wherein the guide comprises a printed guide.

6. The system of claim 1, wherein the guide comprises an on-line guide.

7. The system of claim 1, wherein the software program comprises an updated version of the software program.

8. The system of claim 1, wherein the software program comprises a file transfer protocol software program, and the guide further comprises file transfer protocol software program instructions.

9. The system of claim 1, wherein the network comprises an internal network, and the guide further comprises network dial-up connection instructions.

10. The system of claim 1, further comprising server accessing instructions.

11. The system of claim 1, wherein the telecommunications equipment comprises a multiplexer.

12. The system of claim 1, wherein the software program accessing instructions further comprise software program instructions for the telecommunications equipment of a plurality of vendors.

13. The system of claim 1, wherein the software program comprises a digital loop electronics software program.

14. The system of claim 1, wherein the software program comprises a testing software program.

15. The system of claim 1, wherein the software program accessing instructions further comprise mobile computer tool software program instructions.

16. The system of claim 1, wherein the software program accessing instructions further comprise mobile computer radio servicing software program instructions.

17. The system of claim 1, wherein the software program accessing instructions further comprise telecommunications equipment servicing job aid software program instructions.

18. A system for transferring a software program comprising:
a server having access to the software program;
a mobile computer in communication with the server over a network for receiving the software program from the server;
a computerized guide system including:
instructions for accessing a software program on the server;
instructions for downloading the software program from the server to the mobile computer;
instructions for connecting the mobile computer to the telecommunications equipment;
instructions for accessing the software program downloaded onto the mobile computer; and
instructions for transferring the software program from the mobile computer to the equipment,
wherein instructions for accessing, downloading, and transferring the software program are accessible at a plurality of locations at the same time to a plurality of technicians servicing the telecommunications equipment.

19. The system of claim 18, wherein each set of instructions further comprises self-guided instructions adapted for independent use by a technician.

20. The system of claim 18, wherein at least one set of instructions further comprises a display of an icon.

21. The system of claim 20, wherein the icon is associated with the software program and the at least one set of instructions further comprises a description of the software program associated with the icon.

22. The system of claim 18, wherein the guide comprises a printed guide.

23. The computerized guide system of claim 18, wherein the guide comprises an on-line guide.

24. The system of claim 18, wherein the software program comprises an updated version of the software program.

25. The system of claim 18, wherein the software program comprises a file transfer protocol software program, and the guide further comprises instructions for using the file transfer protocol software program.

26. The system of claim 18, wherein the network comprises an internal network, and the guide further comprises instructions for making a dial-up connection to the network from the mobile computer.

27. The system of claim 18, further comprising instructions for accessing the server.

28. The system of claim 18, wherein the telecommunications equipment comprises a multiplexer.

29. The system of claim 18, wherein the instructions for accessing a software program on the server further comprise instructions for accessing software programs for the telecommunications equipment of a plurality of vendors.

30. The system of claim 18, wherein the software program comprises a digital loop electronics software program.

31. The system of claim 18, wherein the software program comprises a testing software program.

32. The system of claim 18, wherein the instructions for accessing a software program on the server further comprise instructions for accessing and using software programs for mobile computer tools.

33. The system of claim 18, wherein the instructions for accessing a software program on the server further comprise instructions for accessing and using software programs for servicing radio functions on mobile computers.

34. The system of claim 18, wherein the instructions for accessing a software program on the server further comprise instructions for accessing and using software programs adapted as job aids for servicing the telecommunications equipment.
